(19) United States
(12) Patent Application Publication
(10) Pub. No.: US 2010/0047512 A1
(43) Pub. Date: Feb. 25, 2010

(54) METHODOLOGY AND TOOLING ARRANGEMENTS FOR STRENGTHENING A SURFACE BOND IN A HYBRID CERAMIC MATRIX COMPOSITE STRUCTURE

(76) Inventors: Jay A. Morrison, Oviedo, FL (US); Gary B. Merrill, Orlando, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/194,108

(22) Filed: Aug. 19, 2008

(51) Int. Cl. B32B 5/08; B05D 3/12; B32B 18/00

(52) U.S. Cl. 428/86; 427/292; 427/299; 428/688

(57) ABSTRACT

A ceramic matrix composite (CMC) structure and methods of fabricating such structure are disclosed. In one example, the surface of a CMC substrate (12) is urged against a surface of a tool having blunt teeth. The blunt teeth can form surface indents that can serve as a first bond-enhancing arrangement between the surface of the substrate and a corresponding boundary of a thermally-insulating coating (14). In another example, sharp teeth can form surface indents and also penetrate through the surface of the substrate to cut some of the fibers beneath the surface of the substrate into split fiber segments, and a portion of the split fiber segments can protrude above the surface of the substrate. The protruding fiber segments can serve as a second bond-enhancing arrangement between the surface of the substrate and the corresponding boundary of the coating.

### FIELD OF THE INVENTION

The present invention is generally related to ceramic structures for use in a high temperature combustion environment, and, more particularly, to structural arrangements and techniques for strengthening a surface bond between corresponding surfaces of an insulating ceramic coating and ceramic matrix composite (CMC) substrate, which is thermally protected by the ceramic coating.

### BACKGROUND OF THE INVENTION

Engine components in the hot gas flow of modern combustion turbines are required to operate at ever-increasing temperatures as engine efficiency requirements continue to advance. Ceramics typically have higher heat tolerance and lower thermal conductivities than metals, particularly in the case of oxide-based ceramic materials. For this reason, ceramics have been used both as structural materials in place of metallic materials and as coatings for both metal and ceramic structures. Ceramic matrix composite (CMC) wall structures with ceramic insulation outer coatings, such as described in commonly owned U.S. Pat. No. 6,197,424, have been developed to provide components with the high temperature stability of ceramics without the brittleness of monolithic ceramics.

The versatility of an insulated CMC material may be influenced by the strength of the bond between the insulation and the structural CMC material. For example, some environments and/or engine components may require an incremental bonding strength relative to a baseline bond strength Accordingly, further improvements that increment the bonding strength between the insulation and the structural CMC material are desired.

### BRIEF DESCRIPTION OF THE DRAWINGS

The invention is explained in the following description in view of the drawings that show:

FIG. 1 is a partial cross-sectional view of a hybrid ceramic structure for use in a high temperature combustion environment.

FIG. 2 is an isometric view of an example tooling arrangement having a sufficiently high degree of sharpness to provide a desired cutting action through a surface of the hybrid ceramic structure.

FIG. 3 is an isometric view of an example representation of the surface of the hybrid ceramic structure subsequent to a pressure engagement by the tooling arrangement of FIG. 2.

FIG. 4 is an isometric view of another example tooling arrangement having a sufficiently low degree of sharpness to provide a desired blunting action to a surface of the hybrid ceramic structure.

FIG. 5 is an isometric view of an example representation of the surface of the hybrid ceramic structure subsequent to a pressure engagement by the tooling arrangement of FIG. 4.

FIG. 6 is a partial cross-sectional view of an example tooling arrangement that combines in a common tool the tooling arrangements of FIGS. 2 and 4.

FIG. 7 is a partial cross-sectional view that illustrates example fiber warping that may occur when a surface of a ceramic substrate is urged with respect to a blunt tooling arrangement.

FIG. 8 is a comparative plot of examples of enhanced bonding strength, as obtained in accordance with aspects of the present invention, relative to a baseline bonding strength.

### DETAILED DESCRIPTION OF THE INVENTION

FIG. 1 is a partial cross-sectional view of a finished hybrid ceramic structure 10 for use in a high temperature combustion environment, such as in a gas turbine engine. The hybrid ceramic structure 10 is formed of a substrate 12 of an oxide-based ceramic matrix composite (CMC) material that is thermally protected by a thermally-insulating ceramic coating 14. The ceramic matrix composite substrate 12 and ceramic coating 14 may be of the type described in U.S. Pat. No. 6,013,592, incorporated by reference herein. The ceramic matrix composite substrate 12 includes at least one layer of ceramic fibers beneath a surface of the substrate. Ceramic coating 14 may be an oxide-based ceramic including a matrix material 16 surrounding a plurality of mullite (or alumina rich mullite) geometric shapes 18 (e.g., spheres). The matrix material 16 may include a mullite or alumina rich mullite filler powder and a phosphate binder or an alumina filler powder and an alumina binder. One or more optional oxide bond layers (not shown) may be disposed between the ceramic matrix composite substrate 12 and the ceramic insulating coating 14 and may comprise one or more of the group of mullite, alumina, and zirconia or other stable oxide materials of similar range coefficients of thermal expansion.

The inventors of the present invention propose structural arrangements and techniques conducive to strengthening a surface bond between corresponding surfaces of insulating ceramic coating 14 and CMC substrate 12. Aspects of the present invention propose tooling arrangements and methodology innovatively adapted to affect the bonding characteristics between such surfaces.

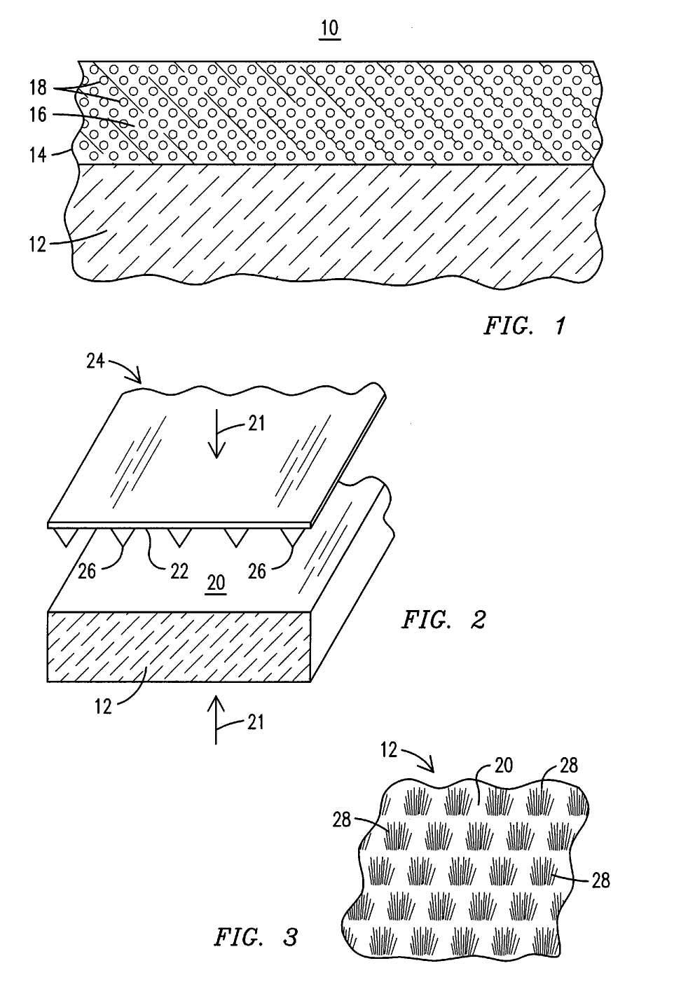

As shown in FIG. 2, a surface 20 of the CMC substrate 12 may be urged (e.g., by way of a mechanism that produces a pressure force, as schematically represented by arrows 21) with respect to a surface 22 of a tool 24, as may have a plurality of teeth 26 arranged in accordance with a predefined pattern. In one example embodiment, the teeth 26 of the tool have a first degree of sharpness. For example, the first degree of sharpness may be sufficiently sharp to provide a desired cutting action through portions of surface 20.

As a result of the urging (e.g., pressure force) applied to the opposing surfaces, teeth 26 penetrate through the surface of the substrate to cut at least some of the fibers beneath the surface of the substrate into split fiber segments 26, as conceptually represented in FIG. 3. As a result of the cutting action, a portion of the split fiber segments 28 can protrude above the surface of the substrate while remaining attached to the underlying substrate. At this stage, the ceramic insulating coating 14 may be deposited on the surface of the ceramic substrate, and, in this example embodiment, the protruding fiber segments constitute a first bond-enhancing arrangement between the surface of the ceramic substrate and a corresponding boundary of the coating.

In another example embodiment shown in FIG. 4, in addition or in lieu of the cutting arrangement discussed above, one can further arrange in surface 22 of tool 24 at least a second set of teeth 34 having a second degree of sharpness different than the first degree of sharpness. For example, the second degree of sharpness may be sufficiently blunt or dull to provide a desired blunting action to portions of the CMC substrate surface 20. Thus, in this example embodiment teeth 34 function as blunting elements. As a result of the urging of tool surface 22, the teeth with the second degree of sharpness form a plurality of surface indents 36 on the surface 20 of the CMC substrate, as represented in FIG. 5. It will be appreciated that the blunting arrangement and corresponding surface indents need not be made up of discrete features. For example, it is contemplated that the blunting arrangement and corresponding surface indents could be made up of elongated (e.g., linear or curved) features, as may extend over the surface of the OMC substrate.

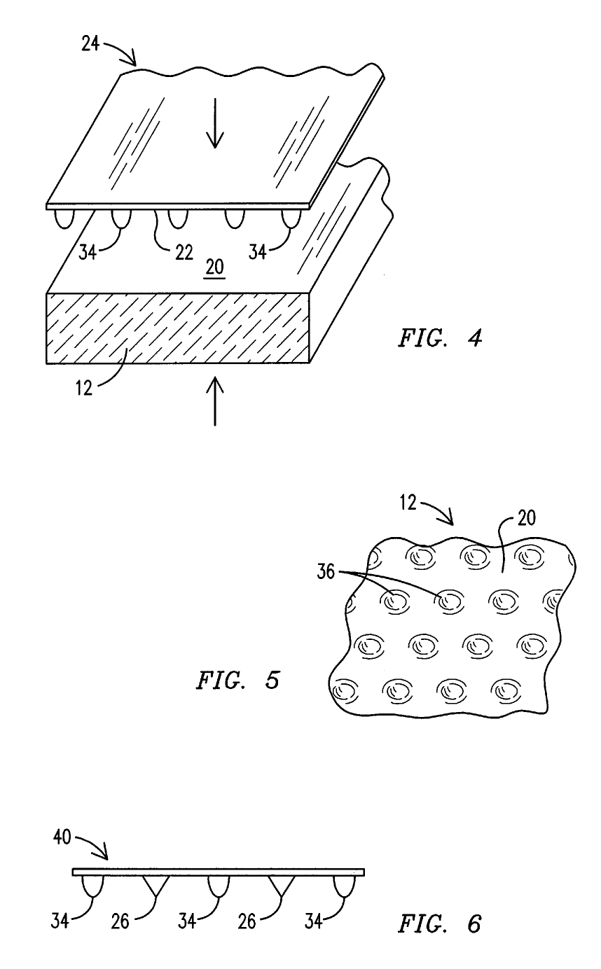

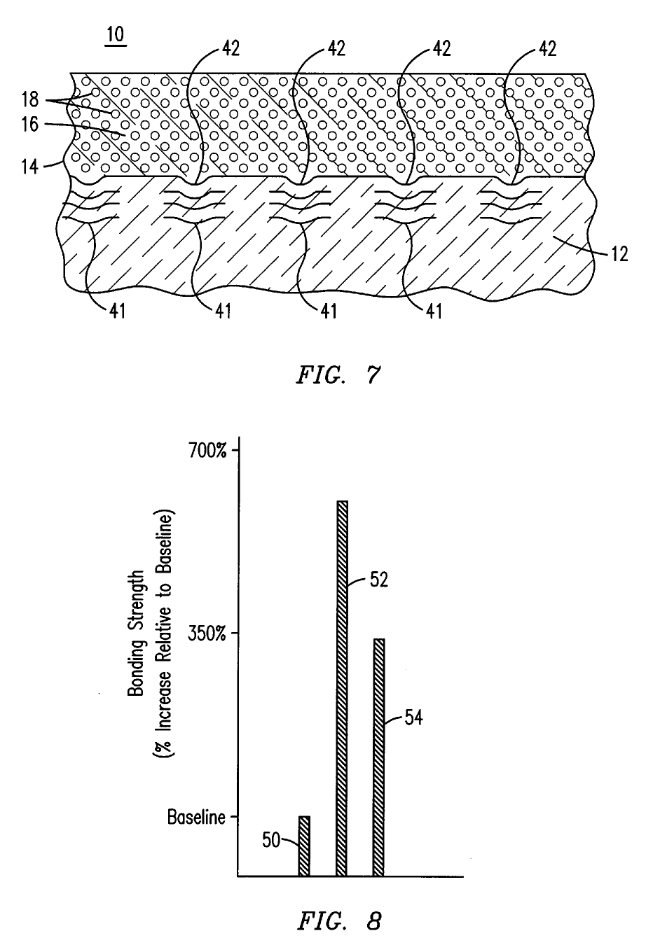

It is contemplated that in one practical embodiment the respective sets of teeth having the first degree of sharpness and the second degree of sharpness will be arranged in a common tool 40 as illustrated in FIG. 6. However, it is contemplated that the different sets of teeth could be arranged in two different tools or in two separate portions of the same tool in the event a given application may use just the blunting action for one portion of the geometry and the cutting action for another portion. It will be appreciated that in a practical embodiment, the sharp teeth can also contribute to the formation of surface indents on the surface of the substrate. Thus, the sharp teeth may provide the fiber-cutting feature in combination with formation of surface indents.

In a practical embodiment, the urging force may correspond to a laminate consolidation pressure normally applied during a laminate (e.g., inter-layer) consolidation stage—usually a pressure that in one example embodiment may range from approximately 10 psi to approximately 200 psi. Furthermore, such consolidation normally is applied by a standard tooling (e.g., hard plate) on at least one side of the laminate. Thus, it is contemplated that a tooling arrangement embodying aspects of the present invention may be integrated into the standard tooling used for consolidation and thus it is believed that aspects of the present invention do not entail a post-consolidation process step or adding extra manufacturing steps. It will be appreciated that the values of the consolidation pressure may be adjusted based on the needs of a given application, e.g., size and/or pattern of features.

In this example embodiment, the plurality of surface indents 36 constitutes a second bond-enhancing arrangement between the surface 20 of the ceramic substrate and the corresponding boundary of the coating. Indents enhance the bonding strength by increasing whetted surface area, providing a non-planar crack propagation surface, and allowing the coating particles to nest within the surface of the substrate and span the substrate-coating interface. Thus, in an example embodiment that includes both a cutting arrangement and/or a blunting arrangement, the first and second bond-enhancing arrangements provide in combination a mechanical bonding arrangement between the surface of the ceramic substrate and the corresponding boundary of the coating.

It will be appreciated that the depth and inter-spacing of such indents can be adjusted for a given application based, for example, on any given fiber or fabric characteristics of the substrate and/or the expected size of bodies in the coating (e.g., hollow ceramic spheres). In one example embodiment, the inter-spacing and depth of the indents may be configured to partially or completely accept the largest ceramic spheres that may be present in the coating. This may provide a fit to the spheres conducive to further increment the bonding and avoid characteristics of the interface that can promote crack propagation and delamination. In this example embodiment, the spacing between respective centers of the indents may range from about equal to the diameter (D) of the largest sphere to about an order of magnitude greater than the largest sphere's diameter (e.g., from about D to about 10D). Similarly, the depth of the indents may range from about 20% to about 200% of the diameter (D) of the largest sphere (e.g., from about 0.2D to about 2D). For readers desirous of general background information regarding example considerations for choosing the inter-spacing and depth of the surface indents, in connection with achieving a desired fit with the spheres in the thermal coating, reference is made to U.S. patent application Ser. No. 11/600,709, filed on Nov. 16, 2006 titled “Ceramic Matrix Composite Surfaces With Open Features For Improved Bonding To Coatings”, assigned to the same assignee of the present invention and herein incorporated by reference.

FIG. 7 is a partial cross-sectional view that illustrates an example of fiber warping that may occur when the surface of the ceramic substrate is urged with respect to the blunting tooling arrangement. For example, at least some of the fibers beneath the surface of the substrate (e.g., fibers 41) in correspondence with respective surface indents 42 will undergo some fiber warping as a result of the urging of the surface of the CMC substrate with respect to the blunting arrangement. The impact of such surface distortions on the in-plane properties of oxide-based CMCs is minimal, due to their notch insensitivity. For small scale indents or surface cuts (e.g., <1 mm), there is virtually no in-plane property debit—based on studies of through-holes.

The disclosure above describes various example tooling arrangements that may include a first set of teeth having a first degree of sharpness, a second set of teeth having a second degree of sharpness, and a combination of such arrangements. It will be appreciated by those skilled in the art, that such tooling arrangements are not limited to tooling arrangements having teeth-like projections since many other arrangements may equally provide the desired cutting action and/or blunting action. For example, it is contemplated that a suitably configured wire mesh arrangement may be used in the tooling arrangement. It is further contemplated that a prismatic light diffuser, such as may be made from plastic, may be used equally effective in the tooling arrangement. Accordingly, as used in the present disclosure, the term “teeth” should not be construed as being limited to teeth-like projections from the surface of the tool.

Example variations in the tooling arrangement may include the distribution, spacing, pattern, and depth of the indents or tooling features. Although example penetration depths explored so far (e.g., ranging from approximately 1 mm to approximately 3 mm) and spacing (e.g., ranging from approximately 3 mm to approximately 10 mm) have proven effective, it is contemplated that tooling arrangements that may include pattern variations and/or random depth variation may further strengthen the resulting surface bond.

FIG. 8 is a comparative plot of examples of enhanced bonding strength, as obtained in accordance with aspects of the present invention, relative to a known baseline bonding strength represented by bar 50. Bar 52 represents an example of enhanced bonding strength obtained when using protruding fiber segments to produce the bond-enhancing arrangement. Bar 54 represents an example of enhanced bonding strength obtained when using surface indents to produce the bond-enhancing arrangement.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method of fabricating a hybrid ceramic matrix composite structure, said method comprising:
forming a ceramic matrix composite substrate including at least one layer of ceramic fibers beneath a surface of the substrate;
urging the surface of the substrate with respect to a surface of a tool having a plurality of teeth, wherein at least a first set of the teeth of the tool has a first degree of sharpness;
as a result of said urging, the teeth penetrating through the surface of the substrate to cut at least some of the fibers beneath the surface of the substrate into split fiber segments;
at least a portion of the split fiber segments protruding above the surface of the substrate while remaining attached to the underlying substrate; and
depositing a ceramic coating on the surface of the substrate, wherein said protruding fiber segments constitute a first bond-enhancing arrangement between the surface of the substrate and a corresponding boundary of the coating.

2. The method of claim 1, further comprising arranging in the surface of the tool at least a second set of teeth having a second degree of sharpness different than the first degree of sharpness.

3. The method of claim 2, wherein, as a result of said urging, the teeth with the second degree of sharpness forming a plurality of surface indents on the surface of the substrate, wherein the plurality of surface indents constitutes a second bond-enhancing arrangement between the surface of the substrate and the corresponding boundary of the coating.

4. The method of claim 3, wherein the teeth with the first degree of sharpness further forming surface indents on the surface of the substrate, said surface indents being part of the second bond-enhancing arrangement between the surface of the substrate and the corresponding boundary of the coating.

5. The method of claim 1 wherein the urging is performed in response to a laminate consolidation pressure applied to the substrate during a laminate consolidation stage.

6. A method of fabricating a hybrid ceramic matrix composite structure, said method comprising:
forming a ceramic matrix composite substrate including at least one layer of ceramic fibers beneath a surface of the substrate;
urging the surface of the substrate with respect to a surface of a tool having a plurality of blunt teeth;
as a result of said urging, the blunt teeth forming a plurality of surface indents on the surface of the substrate; and
depositing a ceramic coating on the surface of the substrate, wherein said surface indents constitute a first bond-enhancing arrangement between the surface of the substrate and a corresponding boundary of the coating.

7. The method of claim 6, further comprising arranging in the surface of the tool a plurality of sharp teeth.

8. The method of claim 7, wherein, as a result of said urging, the sharp teeth penetrating through the surface of the substrate to cut at least some of the fibers beneath the surface of the substrate into split fiber segments, and further wherein at least a portion of the split fiber segments protrude above the surface of the substrate while remaining attached to the underlying substrate, said protruding fiber segments constituting a second bond-enhancing arrangement between the surface of the substrate and the corresponding boundary of the coating.

9. The method of claim 8, wherein the sharp teeth further forming surface indents on the surface of the substrate, said surface indents being part of the first bond-enhancing arrangement between the surface of the substrate and the corresponding boundary of the coating.

10. The method of claim 6, wherein the urging is performed in response to a laminate consolidation pressure applied to the substrate during a laminate consolidation stage.

11. A method of fabricating a hybrid ceramic matrix composite structure, said method comprising:
forming a ceramic matrix composite substrate including at least one layer of ceramic fibers beneath a surface of the substrate;
urging the surface of the substrate with respect to a surface of a tool having a plurality of teeth, wherein at least a first set of the teeth of the tool has a first degree of sharpness, and at least a second set of teeth has a second degree of sharpness different than the first degree of sharpness;
as a result of said urging, the teeth with the first degree of sharpness penetrating through the surface of the substrate to cut at least some of the fibers beneath the surface of the substrate into split fiber segments, and the teeth with the second degree of sharpness forming a plurality of surface indents on the surface of the substrate;
at least a portion of the split fiber segments protruding above the surface of the substrate while remaining attached to the underlying substrate;
depositing a ceramic coating on the surface of the substrate, wherein said protruding fiber segments constitute a first bond-enhancing arrangement between the surface of the substrate and a corresponding boundary of the coating, and further wherein the plurality of surface indents constitutes a second bond-enhancing arrangement between the surface of the substrate and the corresponding boundary of the coating, said first and second bond-enhancing arrangements providing in combination a mechanical bonding arrangement between the surface of the substrate and the corresponding boundary of the coating.

12. The method of claim 11, wherein the first set of teeth and the second set of teeth are arranged in a common tool.

13. The method of claim 12, wherein the urging of the surface of the substrate with respect to the surface of the tool comprises a single urging action.

14. The method of claim 11, wherein the urging is performed in response to a laminate consolidation pressure applied to the substrate during a laminate consolidation stage.

15. The method of claim 11, further comprising arranging the respective sets of teeth over the surface of the tool in accordance with a respective pattern.

16. The method of claim 15, further comprising selecting the respective pattern from the group consisting of a random pattern, a geometric pattern and a combination of said patterns.

17. The method of claim 11, further comprising varying at least one physical characteristic of the respective sets of teeth, wherein the at least one physical characteristics includes at least one of the following: size and shape of the teeth in the respective sets.

18. The method of claim 11, wherein the teeth with the first degree of sharpness further forming surface indents on the surface of the substrate, said surface indents being part of the second bond-enhancing arrangement between the surface of the substrate and the corresponding boundary of the coating.

19. A hybrid ceramic matrix composite structure, comprising:
a ceramic matrix composite substrate including at least one layer of ceramic fibers beneath a surface of the substrate, wherein at least some of the fibers beneath the surface of the substrate are split with a cutting tool into fiber segments that protrude above the surface of the substrate while remaining attached to the underlying substrate; and
a ceramic coating deposited on the surface of the ceramic substrate, wherein the protruding fiber segments constitute a first bond-enhancing arrangement between the surface of the ceramic substrate and a corresponding boundary of the coating.

20. The structure of claim 19, further comprising a plurality of surface indents on the surface of the substrate, wherein at least some of the plurality of surface indents are formed as a result of urging the surface of the substrate with respect to a blunt tool, wherein the plurality of surface indents constitutes a second bond-enhancing arrangement between the surface of the ceramic substrate and the corresponding boundary of the coating, and further wherein at least some of the fibers beneath the surface of the substrate in correspondence with respective surface indents undergo a fiber warping as a result of the urging the surface of the substrate with respect to the blunt tool.

21. The structure of claim 20, wherein the respective protruding fiber segments and surface indents are arranged in accordance with a respective pattern.

22. The structure of claim 21, wherein the respective pattern is selected from the group consisting of a random pattern, a geometric pattern and a combination of said patterns.

23. The structure of claim 20, wherein at least one physical characteristic of the surface indents is variable, wherein the at least one physical characteristics includes at least one of the following: size, depth and shape of the respective surface indents.

24. The structure of claim 20, wherein at least some of the surface indents on the surface of the substrate are formed by the cutting tool.

25. A hybrid ceramic matrix composite structure, comprising:
a ceramic matrix composite substrate including at least one layer of ceramic fibers beneath a surface of the substrate, the surface of the substrate including a plurality of surface indents, wherein at least some of the plurality of surface indents is formed as a result of urging the surface of the substrate with respect to a blunt tool, wherein at least some of the fibers beneath the surface of the substrate in correspondence with respective surface indents undergo a fiber warping as a result of the urging the surface of the substrate with respect to the blunt tool; and
a ceramic coating deposited on the surface of the ceramic substrate, wherein the surface indents constitute a first bond-enhancing arrangement between the surface of the substrate and a corresponding boundary of the coating.

26. The structure of claim 25, wherein at least some of the fibers beneath the surface of the substrate are split with a cutting tool into fiber segments that protrude above the surface of the substrate while remaining attached to the underlying substrate, wherein the protruding fiber segments constitute a second bond-enhancing arrangement between the surface of the ceramic substrate and the corresponding boundary of the coating.

27. The structure of claim 25, wherein a depth of the surface indents range from approximately 1 mm to approximately 3 mm.

28. The structure of claim 25, wherein a distance spacing between adjacent surface indents ranges from approximately 3 mm to approximately 10 mm.

29. The structure of claim 25, wherein the ceramic coating includes a plurality of hollow ceramic spheres.

30. The structure of claim 29, wherein the surface indents have a center-to-center separation distance that ranges from 100% to 1,000% of a diameter of the hollow ceramic spheres in the coating and a depth that ranges from 20% to 200% of the diameter of said hollow ceramic spheres.

31. The structure of claim 26, wherein at least some of the surface indents on the surface of the substrate are formed by the cutting tool.
